(19) United States
(12) Patent Application Publication
(10) Pub. No.: US 2008/0245621 A1
(43) Pub. Date: Oct. 9, 2008

(54) Dual disc brake assembly

(75) Inventors: Jean Friderich, Poissy (FR); Eric Padiolleau, Morienval (FR)

Correspondence Address: DELPHI TECHNOLOGIES, INC., M/C 480-410-202, PO BOX 5052, TROY, MI, 48007, US

(73) Assignee: DELPHI TECHNOLOGIES, INC., Tory, MI (US)

(21) Appl. No.: 11/784,017

(22) Filed: Apr. 5, 2007

(51) Int. Cl. F16D 55/08

(52) U.S. Cl. 188/72.1

(57) ABSTRACT

A disc brake assembly including a caliper bracket, a caliper housing having an outer portion and an inner portion, the inner portion defining a piston bore therein, wherein the caliper housing is moveable relative to the caliper bracket, a caliper piston received within and extendable from the piston bore, an elastic element positioned relative to the caliper housing and the caliper bracket, and a disc rotor assembly including a hub and at least two rotors, each of the rotors having at least two friction surfaces, at least a portion of each of the friction surfaces being positioned between the outer portion of the caliper housing and the caliper piston, wherein the caliper housing moves relative to the caliper bracket when the caliper piston extends from the piston bore to engage the disc rotor assembly, thereby deforming the elastic element.

### BACKGROUND

The present application is directed to dual disc brake assemblies and, more particularly, to dual disc brake assemblies with reduced drag torque.

Brake systems for passenger cars traditionally have employed a single rotor apparatus with either a fixed caliper with opposing pistons or a floating caliper with a single piston. Dual disc brake systems have been developed as an improvement over such single rotor systems. Dual disc brake systems typically utilize two (or more) rotors and associated friction surfaces to maximized brake torque, while reducing brake assembly packaging size.

Typical dual disc brake systems have a fixed caliper housing, wherein a caliper piston pushes an inner pad, which urges a first rotor into engagement with a second shoe having two friction pads mounted, which urges the second rotor into the outer pad. However, such systems often develop a drag torque during high pressure applies. It is believed that the drag torque results, at least in part, from a failure of the sliding elements to return to their respective initial positions.

Accordingly, there is a need for a dual disc brake system wherein the effects of drag torque are reduced or eliminated.

### SUMMARY

In one aspect, the disclosed dual disc brake assembly may include a caliper bracket, a caliper housing having an outer portion and an inner portion, the inner portion defining a piston bore therein, wherein the caliper housing is moveable relative to the caliper bracket, a caliper piston received within and extendable from the piston bore, an elastic element positioned relative to the caliper housing and the caliper bracket, and a disc rotor assembly including a hub and at least two rotors, each of the rotors having at least two friction surfaces, at least a portion of each of the friction surfaces being positioned between the outer portion of the caliper housing and the caliper piston, wherein the caliper housing moves relative to the caliper bracket when the caliper piston extends from the piston bore to engage the disc rotor assembly, thereby deforming the elastic element.

In another aspect, the disclosed dual disc brake assembly may include a caliper bracket defining a threaded recess, a caliper housing having an outer portion and an inner portion, the inner portion defining a piston bore therein and including a mounting ear extending therefrom, the mounting ear defining a bolt-receiving bore therein, a mounting bolt including a threaded portion, a guiding length portion and a bolt head, wherein the mounting bolt extends through the bolt-receiving bore and the threaded portion of the mounting bolt engages the threaded recess in the caliper bracket, thereby moveably connecting the caliper housing to the caliper bracket, a caliper piston received within and extendable from the piston bore, an elastic element positioned between the bolt head and the mounting ear, and a disc rotor assembly including a hub and two rotors extending radially from the hub, a portion of each of the rotors being positioned between the caliper piston and the outer portion of the caliper housing, wherein the caliper housing is adapted to move along the guiding length portion of the mounting bolt and deform the elastic element when the caliper piston extends from the piston bore to engage the rotors.

Other aspects of the disclosed dual disc brake assembly will become apparent from the following description, the accompanying drawings and the appended claims.

### BRIEF DESCRIPTION OF THE DRAWINGS

FIG. 1 is a side elevational view, partially in section, of one aspect of the disclosed dual disc brake assembly in a first, relaxed configuration;

FIG. 2 is a side elevational view, partially in section, of a portion of the dual disc brake assembly of FIG. 1; and

FIG. 3 is a side elevational view, partially in section, of the dual disc brake assembly of FIG. 1 in a second, actuated configuration.

### DETAILED DESCRIPTION

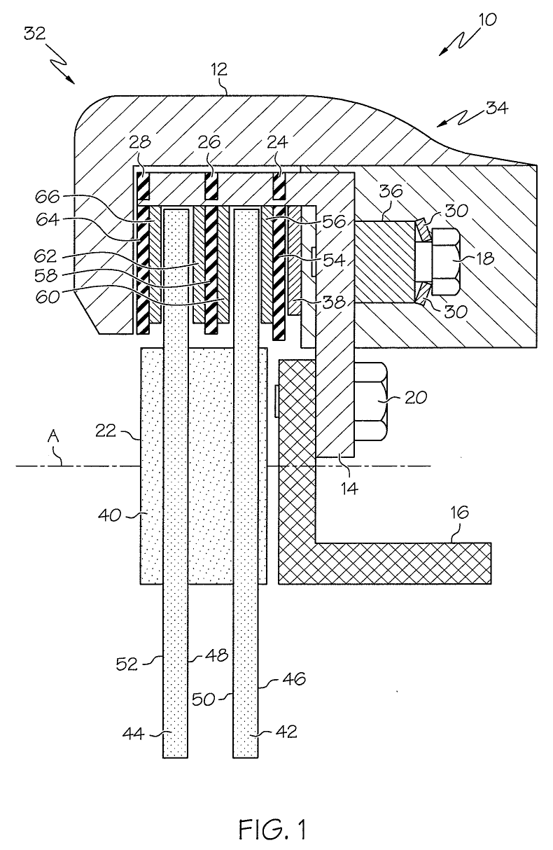

Referring to FIG. 1, one aspect of the disclosed dual disc brake assembly, generally designated 10, may include a caliper housing 12, a caliper bracket 14, a knuckle 16, a bracket mounting bolt 18, a knuckle mounting bolt 20, a dual disc rotor assembly 22, an inner brake pad assembly 24, a center brake pad assembly 26, a outer brake pad assembly 28 and an elastic element 30. The knuckle 16 may be connected to a vehicle, such as a passenger car, a sport utility vehicle, a motorcycle, an airplane or the like.

The caliper housing 12 may include a outer portion 32 and an inner portion 34. The inner portion 34 of the housing 12 may include caliper housing mounting ears 36 (only one shown in FIGS. 1-3) and may define an internal piston bore (not shown). A caliper piston 38 may be slideably received in and extendable from the piston bore in the housing 12.

The disc rotor assembly 22 may include a hub 40, an inner rotor 42 and an outer rotor 44 and may be rotateable about an axis A. Optionally, the rotors 42, 44 may be moveable (e.g., slideable) relative to each other and/or the hub 40. The rotors 42, 44 may extend radially from the hub 40 and may include inner 46, 48 and outer 50, 52 friction surfaces, respectively, adapted to be engaged by the brake pad assemblies 24, 26, 28.

At this point, those skilled in the art will appreciate that additional rotors may be used with assembly 10 without departing from the scope of the present disclosure. For example, the rotor assembly 22 may include three rotors, each of which may have two frictions surfaces.

The inner brake pad assembly 24 may include a shoe 54 and a friction portion 56, the center brake pad assembly 26 may include a shoe 58, a first friction portion 60 and a second friction portion 62, and the outer brake pad assembly 28 may include a shoe 64 and a friction portion 66. Friction portion 56 of the inner brake pad assembly 24 may engage the inner friction surface 46 of the inner rotor 42, the first friction portion 60 of the center brake pad assembly 26 may engage the outer surface 50 of the inner rotor 42, the second friction portion 62 of the center brake pad assembly 26 may engage the inner surface 48 of the outer rotor 44 and the friction portion 66 of the outer brake pad assembly 28 may engage the outer surface 52 of the outer rotor 44.

The inner, center and outer brake pad assemblies 24, 26, 28 may be slideably mounted on the caliper bracket 14. However, those skilled in the art will appreciate that any available technique and/or device may be employed to mount the brake pad assemblies 24, 26, 28 relative to the friction surfaces 46, 48, 50, 52 of the rotors 42, 44.

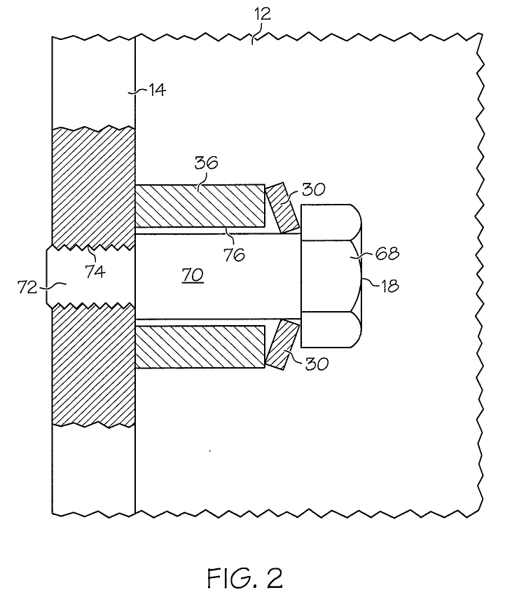

Referring to FIG. 2, the bracket mounting bolt 18 may include a bolt head 68, a guiding length portion 70 and a threaded portion 72. The threaded portion 72 of the bolt 18 may be sized and shaped to engage a threaded recess 74 in the caliper bracket 14. Each caliper housing mounting ear 36 may define a bore 76 extending therethrough and the bore 76 may be sized and shaped to receive the guiding length portion 70 of the bracket mounting bolt 18 therein.

The elastic element 30 may be any biasing device that may be positioned relative to the caliper housing 12 and the caliper bracket 14 to bias the caliper housing 12 relative to the caliper bracket 14. In one aspect, the elastic element 30 may be positioned between the bolt head 68 of the bracket mounting bolt 18 and the caliper housing mounting ear 36 to bias the caliper housing mounting ear 36 away from the bracket mounting bolt 18. For example, the elastic element 30 may be a Belleville washer (shown in FIGS. 1-3), a rubber bushing, a spring, a low stiffness element or the like and may establish a biasing force when deformed.

Referring to FIGS. 1 and 2, in one aspect, the dual disc brake assembly 10 may be assembled by securing the caliper bracket 14 to the knuckle 16 using the knuckle mounting bolt 20, mounting the inner, center and outer brake pad assemblies 24, 26, 28 on the caliper bracket 14 such that the brake pad assemblies 24, 26, 28 are positioned to engage the friction surfaces 46, 48, 50, 52 of the rotors 42, 44, and securing the caliper housing 12 to the caliper bracket 14 using the bracket mounting bolt 18. In one particular aspect, the elastic element 30 may be received over the guiding length portion 70 of the bracket mounting bolt 18 and the bracket mounting bolt 18 may be passed through the bore 76 of the caliper housing mounting ear 36 such that the threaded portion 72 of the bolt 18 engages the threaded recess 74 in the caliper bracket 14, thereby securing the caliper housing 12 to the caliper bracket 14.

In the assembled configuration, the elastic element 30 may be positioned between the bolt head 68 of the bracket mounting bolt 18 and the caliper housing mounting ear 36. The elastic element 30 may urge the caliper housing mounting ear 36 and the associated caliper housing 12 in a direction away from the bolt head 68, thereby biasing the caliper housing 12 relative to the caliper bracket 14.

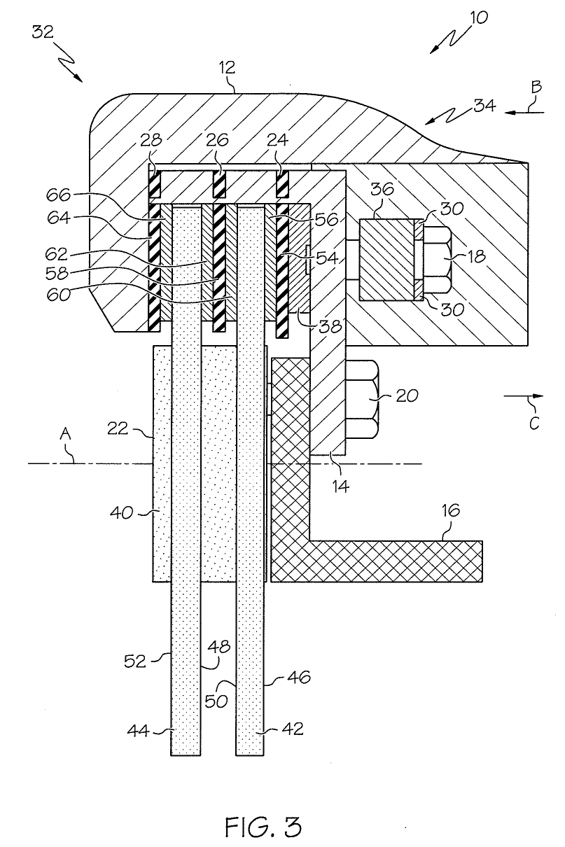

Referring to FIG. 3, when the assembly 10 is actuated, the caliper piston 38 may be urged in the distal direction (arrow B), which may urge the inner brake pad assembly 24 into engagement with the inner rotor 42, which may urge the inner rotor 42 into engagement with the center brake pad assembly 26, which may urge the center brake pad assembly 26 into engagement with the outer rotor 44, which may urge the outer rotor 44 into engagement with outer brake pad assembly 28. Simultaneously, the reaction force of the advancing caliper piston 38 may overcome the biasing force of the elastic element 30, thereby urging the caliper housing 12 in the proximal direction (arrow C) along the guiding length portion 70 (FIG. 2) of the bracket mounting bolt 18. As the caliper housing 12 is urged in the proximal direction, the brake pad assemblies 24, 26, 28 and rotors 42, 44 may be clamped between the caliper piston 38 and the outer portion 32 of the caliper housing 12.

At this point, those skilled in the art will appreciate that the amount of movement or float of the caliper housing 12 during a brake apply may be limited by the length of the bracket mounting bolt 18.

When the brake apply ceases, the caliper piston 38 may be retracted and the elastic element 30 may urge the caliper housing 12 in the distal direction (arrow B) such that the assembly 10 may return to the configuration shown in FIG. 1. Therefore, the elastic element 30 may facilitating disengagement of the friction portion 66 of the outer brake pad assembly 28 from the friction surface 52 of the outer rotor 44 and, accordingly, may reduce or eliminate drag torque.

Although various aspects of the disclosed dual disc brake assembly have been shown and described, modifications may occur to those skilled in the art upon reading the specification. The present application includes such modifications and is limited only by the scope of the claims.

What is claimed is:

1. A disc brake assembly comprising:
a caliper bracket;
a caliper housing having an outer portion and an inner portion, said inner portion defining a piston bore therein, wherein said caliper housing is moveable relative to said caliper bracket;
a caliper piston received within and extendable from said piston bore;
an elastic element positioned relative to said caliper housing and said caliper bracket; and
a disc rotor assembly including a hub and at least two rotors extending from said hub, at least a portion of each of said rotors being positioned between said outer portion of said caliper housing and said caliper piston,
wherein said caliper housing moves relative to said caliper bracket when said caliper piston extends from said piston bore to engage said rotors, thereby deforming said elastic element.

2. (canceled)

3. The disc brake assembly of claim 1 wherein said elastic element is a Belleville washer.

4. The disc brake assembly of claim 1 further comprising a mounting bolt and said caliper housing is moveably connected to said caliper bracket by said mounting bolt.

5. The disc brake assembly of claim 4 wherein said caliper housing includes a mounting ear and said caliper bracket includes a threaded recess, and wherein said mounting bolt extends through said mounting ear and threadedly engages said threaded recess.

6. The disc brake assembly of claim 5 wherein said elastic element is positioned between said mounting ear and said mounting bolt.

7. The disc brake assembly of claim 5 wherein said elastic element is received over said mounting bolt.

8. The disc brake assembly of claim 5 wherein mounting bolt includes a bolt head and said elastic element urges said mounting ear in a direction away from said bolt head.

9. The disc brake assembly of claim 5 wherein said mounting bolt includes a guiding length portion have a length and said movement of said caliper housing relative to said caliper bracket is limited by said length of said guiding length portion.

10. The disc brake assembly of claim 1 further comprising at least three brake pad assemblies, wherein a first one of said brake pad assemblies is positioned between a first one of said rotors and said caliper piston, a second one of said brake pad assemblies is positioned between said first on of said rotors and a second one of said rotors, and a third one of said brake pad assemblies is positioned between said second one of said rotors and said outer portion of said caliper housing.

11. The disc brake assembly of claim 10 wherein said second one of said brake pad assemblies includes a shoe and two friction portions.

12. The disc brake assembly of claim 1 further comprising a knuckle, wherein said caliper bracket is connected to said knuckle.

13. The disc brake assembly of claim 1 wherein said hub is adapted to connected to a wheel of a vehicle.

14. A disc brake assembly comprising:
a caliper bracket defining a threaded recess;
a caliper housing having an outer portion and an inner portion, said inner portion defining a piston bore therein and including a mounting ear extending therefrom, said mounting ear defining a bolt-receiving bore therein;
a mounting bolt including a threaded portion, a guiding length portion and a bolt head, wherein said mounting bolt extends through said bolt-receiving bore and said threaded portion of said mounting bolt engages said threaded recess in said caliper bracket, thereby moveably connecting said caliper housing to said caliper bracket;
a caliper piston received within and extendable from said piston bore;
an elastic element positioned between said bolt head and said mounting ear; and
a disc rotor assembly including a hub and two rotors extending radially from said hub, a portion of each of said rotors being positioned between said caliper piston and said outer portion of said caliper housing,
wherein said caliper housing is adapted to move along said guiding length portion of said mounting bolt and deform said elastic element when said caliper piston extends from said piston bore to engage said rotors.

15. The disc brake assembly of claim 14 wherein elastic element establishes a biasing force when deformed, said biasing force being adapted to urge said caliper housing relative to said caliper bracket.

16. The disc brake assembly of claim 14 wherein said elastic element is a Belleville washer.

17. The disc brake assembly of claim 14 further comprising at least three brake pad assemblies, wherein a first one of said brake pad assemblies is positioned between a first one of said rotors and said caliper piston, a second one of said brake pad assemblies is positioned between said first on of said rotors and a second one of said rotors, and a third one of said brake pad assemblies is positioned between said second one of said rotors and said outer portion of said caliper housing.

18. The disc brake assembly of claim 17 wherein said second one of said brake pad assemblies includes a shoe and two friction portions.

19. The disc brake assembly of claim 14 further comprising a knuckle, wherein said caliper bracket is connected to said knuckle.

20. The disc brake assembly of claim 14 wherein said hub is adapted to connected to a wheel of a vehicle.

21. A disc brake assembly comprising:
a caliper bracket;
a caliper housing defining a piston bore therein, wherein said caliper housing is moveable relative to said caliper bracket;
a caliper piston received within and extendable from said piston bore;
a disc rotor assembly including a hub and at least two rotors extending from said hub, said disk rotor assembly being positioned for engagement by said caliper piston; and
an elastic element positioned relative to said caliper housing and said caliper bracket such that said elastic element is deformed in response to movement of said caliper housing relative to said caliper bracket.
